(19) United States
(12) Patent Application Publication
(10) Pub. No.: US 2011/0168945 A1
(43) Pub. Date: Jul. 14, 2011

(54) Positive active material and method of preparing the same

(75) Inventors: Dong Hyeok Choi, Suwon (KR); Hyun Chul Jung, Yongin (KR); Hak Kwan Kim, Hanam (KR); Jun Hee Bae, Suwon (KR)

(73) Assignee: SAMSUNG ELECTRO-MECHANICS CO., LTD., Suwon (KR)

(21) Appl. No.: 12/805,587

(22) Filed: Aug. 6, 2010

(30) Foreign Application Priority Data
Jan. 8, 2010 (KR) 10-2010-0001777

(51) Int. Cl. H01M 4/485

(52) U.S. Cl. 252/182.1

(57) ABSTRACT

Provided are a positive active material and a method of preparing the same. The positive active material includes LiM_{2-y}N_{y}O₄ (0<y≦2, M and N are transition metals) surface-treated with a nickel (Ni)-containing compound. The positive active material coated with a metal oxide has excellent high-rate discharge performance without a decrease in capacity even at a higher discharge rate in comparison with a capacity at a low discharge rate (C-rate), and a method of preparing the positive active material.

### CROSS-REFERENCE TO RELATED APPLICATIONS

This application claims the priority of Korean Patent Application No. 10-2010-0001777 filed on Jan. 8, 2010, in the Korean Intellectual Property Office, the disclosure of which is incorporated herein by reference.

### BACKGROUND OF THE INVENTION

1. Field of the Invention

The present invention relates to a positive active material and a method of preparing the same, and more particularly, to a positive active material coated with a metal oxide, which has excellent high-rate discharge performance without a decrease in capacity even at a higher discharge rate in comparison with a capacity at a low discharge rate (C-rate), and a method of preparing the positive active material.

2. Description of the Related Art

The basic concept of a rechargeable lithium battery as representative of rechargeable batteries was proposed by Armond in 1980. Since the Sony Corporation, a Japanese company, succeeded in commercializing a LiCoO₂ cathode material for the first time in the early 1990s, various materials such as LiNiO₂, LiMn₂O₄ and LiFePO₄ have been developed to date.

Recently, studies conducted on cathode materials for rechargeable batteries have been mainly directed toward studies into lithium composite oxides containing nanoparticles therein, and studies aimed at improving thermal stability, interfacial properties with an electrolyte, and electrochemical properties by surface-modifying the existing cathode materials using nanoscale heteroatomic compounds.

As an alternative for improving the poor performance of such a cathode material, the development of a nanomaterial manufacturing technology capable of realizing a battery system that can significantly increase a cycle life is required. To this end, the utilization rate and reaction rate should be enhanced by nano-coating a cathode material suitable for battery characteristics or by increasing a reaction area of an electrode through the nanosizing of a material itself and reducing a diffusion path in an electrode active material, thereby realizing a high-capacity and high-power battery with structural stability.

However, across the globe, studies on nanoscale cathode materials are still in their infancy, and a chemical synthetic process such as a sol-gel process, a thermospray process, a combustion process, a molten salt process, or the like has been mostly known as a synthetic method for preparing nanomaterials. It has been demonstrated that such a chemical synthetic process is available for material synthesis and performance improvement under a LAB-scale test. However, it is difficult to actually apply the chemical synthetic process to industrial settings because there remain several problems yet to be surmounted, for example, the large-scale investment required for large-scale equipment, the selection of appropriate raw materials and the resultant increase in cost, as well as repair and maintenance problems.

Due to the problems detailed above, a method of coating the surface of a positive active material with a high conductive material is used to improve the electrochemical property of the positive active material. A nano-sized carbon particle is used as a coating material and a product using such a coating material is currently commercially available. A study into a method of coating hetero-metal oxides in order to improve material properties themselves is also being conducted, in addition to the method of using the nano-sized carbon particle. The method of coating the metal oxides is advantageous in that it is thereby possible to suppress a structural collapse caused by the intercalation/deintercalation of lithium ions inside an active material bulk and also to suppress a side reaction with an electrolyte.

A number of coating methods have been attempted, but the most frequently used methods are as follows. In the case of coating a carbon material, the coating method may employ a method of mixing a solid phase carbon material with a cathode material and then performing a thermal treatment on the mixture, or a method of preparing a gel type carbon material and then coating it on a surface using the reaction between the gel type carbon material and the cathode material. In the case of coating a metal oxide, the coating method is also similar to the carbon material coating method; however, a method of thermally treating and coating a material mixture is performed according to material properties or oxide surface treatment purposes.

In particular, the metal oxide may deteriorate the properties of the positive active material according to a size of a surface treatment material and a coating thickness, and accordingly, a surface treatment should be differently applied in consideration of appropriate materials and techniques.

### SUMMARY OF THE INVENTION

An aspect of the present invention provides a positive active material coated with a metal oxide, which has excellent high-rate discharge performance without a decrease in capacity, even at a higher discharge rate in comparison with a capacity at a low discharge rate (C-rate), and a method of preparing the positive active material.

According to an aspect of the present invention, there is provided a positive active material including LiM_{2-y}N_{y}O₄ (0<y≦2, M and N are transition metals) surface-treated with a nickel (Ni)-containing compound.

Here, the Ni-containing compound may include at least one selected from the group consisting of a nickel oxide (NiO₁₋x, 0≦x<1), a Ni alloy, and Ni.

The surface-treated amount of the Ni-containing compound may be 2% or less by weight.

The transition metal may include at least one selected from the group consisting of titanium (Ti), vanadium (V), chromium (Cr), manganese (Mn), cobalt (Co), and Ni.

According to another aspect of the present invention, there is provided a method of preparing a positive active material, including: preparing a LiM_{2-y}N_{y}O₄ dispersion solution by dissolving LiM_{2-y}N_{y}O₄ powders (0<y≦2, M and N are transition metals) in an alcohol-based solvent; preparing a nickel acetate-LiM_{2-y}N_{y}O₄ compound by adding nickel acetate to the LiM_{2-y}N_{y}O₄ dispersion solution and stirring the resultant mixture; and surface-treating LiM_{2-y}N_{y}O₄ with a Ni-containing compound by thermally treating the nickel acetate-LiM_{2-y}N_{y}O₄ compound in an inert gas atmosphere.

In the surface-treating of the LiM_{2-y}N_{y}O₄, the Ni-containing compound may include at least one selected from the group consisting of a nickel oxide (NiO₁₋ₓ, 0≦x<1), a Ni alloy, and Ni.

In the surface-treating of the LiM_{2-y}N_{y}O₄, the surface-treated amount of the Ni-containing compound may be 2% or less by weight.

The transition metal may include at least one selected from the group consisting of Ti, V, Cr, Mn, Co, and Ni.

In the surface-treating of the LiM_{2-y}N_{y}O₄, the inert gas may use an argon (Ar) gas containing 5% by volume of hydrogen gas (H₂).

Before the surface-treating of the LiM_{2-y}N_{y}O₄, the method may further include drying the nickel acetate-LiM_{2-y}N_{y}O₄ compound.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A to 1C are scanning electron microscope (SEM) images of positive active materials prepared according to an example of the present invention and a comparative example; and

FIGS. 2A and 2B are graphs illustrating charge/discharge properties of batteries according to an example of the present invention and a comparative example.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like reference numerals in the drawings denote like elements, and thus their description will be omitted.

Herebelow, a positive active material according to an embodiment of the present invention and a method of preparing the same will be described by exemplifying a lithium rechargeable battery as a representative rechargeable battery; however, the positive active material and the battery are not limited thereto.

A positive active material used herein, which is represented by LiM_{2-y}N_{y}O₄ (0<y≦2, M and N are transition metals), is obtained by surface-treating a surface of a Mn-based positive active material such as LiMn₂O₄, a substance that is very environmentally-friendly and relatively cheap, with a nickel-containing compound to thereby improve the power density and energy density of LiMn₂O₄ used in a rechargeable battery and an electrochemical battery and to additionally minimize internal resistance.

Here, the transition metal may include at least one selected from the group consisting of titanium (Ti), vanadium (V), manganese (Mn), cobalt (Co) and nickel (Ni).

Here, the Ni-containing compound may include at least one selected from the group consisting of a nickel oxide (NiO₁₋ₓ, 0≦x<1), a Ni alloy and Ni. For example, the Ni-containing compound may be a nickel oxide (NiO₁₋ₓ, 0≦x<1), having excellent conductivity among metal oxides.

The amount of the Ni-containing compound participating in surface treatment is 2% or less by weight, that is, the surface-treated amount of the Ni-containing compound is 2% or less by weight based on the weight of the positive active material. If the surface-treated amount of the Ni-containing compound is 2% or more by weight, the addition of the Ni-containing compound causes capacity to be decreased and thus, excessive metal oxides act as impurities, resulting in an adverse effect on the reaction of the battery.

The Ni-containing compound (particularly, nickel oxide) is a material exhibiting excellent reactivity with hydrofluoric acid (HF). In general, an anhydrous solvent electrolyte may be used as an electrolyte of a lithium rechargeable battery; however, it may contain a little water as an impurity. The water contained in the electrolyte as an impurity reacts with a lithium salt, LiPF₆, contained in the electrolyte to thereby generate a strong acid such as hydrofluoric acid. The generated hydrofluoric acid then attacks a transition metal existing on the surface of the transition metal-based active material so that the transition metal is dissolved in the electrolyte. Consequently, the active material collapses, which causes the service life of the battery, particularly, the service life of the battery at a high temperature, to be significantly decreased.

Compared to this case, a cathode of the lithium rechargeable battery including the positive active material according to the present invention includes a nickel oxide having excellent reactivity with HF acid, and accordingly the nickel oxide rapidly reacts with the HF acid generated in the electrolyte to remove the HF acid that may attack the transition metal. Therefore, it is possible to prevent the transition metal from being dissolved in the electrolyte.

The positive active material of the present invention may further include a binder so as to improve a bonding force with a current collector coated with the positive active material. The binder may use be any binder typically used with positive active material, and a representative examples of the binder may include polyvinylidene fluoride.

The current collector may include a commonly used aluminum foil, but is not limited thereto. Also, the positive active material of the present invention may further include a conductive agent for increasing conductivity. The conductive agent may be any conductive agent typically used for increasing the conductivity of the active material, and representative examples of the conductive agent may include carbon black, and a commercially available carbon material (e.g., Super P™).

Herebelow, a description will be given of a method of preparing a cathode using the positive active material of the present invention having the above constitution.

A lithium salt and a transition metal compound are mixed at a desired equivalence ratio. Typically, the lithium salt may be any lithium salt typically used in preparing a positive active material for a transition metal-based lithium rechargeable battery, and representative examples of the lithium salt may include lithium nitrate, lithium acetate, lithium hydroxide, and the like. The transition metal compound may be any transition metal compound used in preparing the positive active material for the metal transition-based lithium rechargeable battery, and representative examples of the transition metal compound may include transition metal acetate, transition metal dioxide, and the like. To accelerate the reaction between the lithium salt and the metal transition compound, an appropriate solvent such as ethanol, methanol, water, and acetone is added, and solvent-free mortar grinding mixing may then be performed.

The compound of the lithium salt and the transition metal compound, which is manufactured through above-described process, is subjected to a thermal treatment at a temperature ranging from 400° C. to 600° C., thereby obtaining precursor powders of a semi-crystalline positive active material. After the precursor powders of the positive active material obtained through the thermal treatment are dried, or while an inert gas such as Ar is being blown thereupon during the thermal treatment, the precursor powders of the positive active material are remixed at a room temperature and thus the lithium salt may be uniformly distributed.

A lithium rechargeable battery is prepared through a typical method using a cathode, an anode and an anhydrous solvent electrolyte. A method of preparing the anode is well known in a field related to lithium rechargeable batteries, and representative examples of the method include coating a current collector (e.g., a copper foil) with a negative active material slurry containing a negative active material and a binder (e.g., polyvinylidene fluoride), and then drying the current collector coated with the slurry. The negative active material may use all carbon materials typically used for lithium rechargeable batteries, and representative examples of the negative active material may include crystalline graphite that has excellent charge/discharge reversibility as well as voltage flatness properties.

The electrolyte may be generally comprised of an organic solvent used in lithium rechargeable batteries and a lithium salt dissolved in the organic solvent. The organic solvent may include: a ring carbonate such as an ethylene carbonate and methylene carbonate; and a linear carbonate such as dimethyl carbonate, diethyl carbonate, ethylmethyl carbonate and methylpropyl carbonate. Also, the lithium salt dissolved in the organic solvent of the electrolyte may be any lithium salt that enables the acceleration of the movement of lithium ions between the cathode and the anode, and representative examples of the lithium salt may include LiPF₆, LiASF₆, LiCF₃SO₃, LiN(CF₃SO₂)₃, LiBF₆ and LiClO₄.

After a polymer film is impregnated with the electrolyte and a solvent is subsequently volatilized, the electrolyte used may be a gel type polymer electrolyte, or a liquid electrolyte. In the case where the electrolyte is a solid electrolyte, a separator is not additionally required. The separator may use a porous polymer film made of polypropylene or polyethylene, which is widely used in lithium rechargeable batteries generally.

The battery of the present invention is excellent in discharge capacity, high C-rate, and long service life (particularly, service life under high-temperature conditions).

An example of the present invention and a comparative example will hereinafter be described. However, the following example is merely provided exemplarily, and thus the present invention is not limited to example below.

### Example

Positive active material powders of LiMn₂O₄ (made by Korean Phoenix PDE Co., Ltd.) were dispersed in an ethanol solvent using a water-based dispersant of Disperbyk-180 (made by BYK Chemie Company) to thereby prepare a LiMn₂O₄ dispersion solution.

Thereafter, 2% by weight of nickel acetate was added into the LiMn₂O₄ dispersion solution, the solution was stirred for 24 hours, and subsequently dried for 48 hours at 80° C., thereby obtaining a nickel acetate-LiMn₂O₄ compound.

Afterwards, the nickel acetate-LiMn₂O₄ compound was thermally treated for 1 hour at 400° C. in an inert gas atmosphere containing 5% or less by volume of hydrogen gas (H₂), and simultaneously the surface of the nickel acetate-LiMn₂O₄ compound was reduced. Thus, a LiMn₂O₄ positive active material that has been surface-treated with a nickel oxide was prepared.

The prepared positive active material was dispersed in an NMP solvent together with a conductive agent (Super P™) and a binder (polyvinylidene fluoride), and the resultant mixture was applied to Al foil using a doctor blade process. The mixing ratio among the positive active powder, the conductive agent and the binder was 8:1:1 by weight percent. The Al foil coated with the positive active material was dried for 24 hours in an oven at 120° C., and then pressed in order to prepare an anode for a pouch type battery. A half cell was manufactured by using the prepared anode and a Li counter electrode, and also using an electrolyte in which 1M LiPF₆ was dissolved in an organic solvent mixture of ethylene carbonate and dimethyl carbonate (mixed at 1:1 by volume percent).

### Comparative Example

A LiMn₂O₄ (made by Korean Phoenix PDE Co., Ltd.) positive active material was dispersed in an NMP solvent together with a conductive agent (Super P™) and a binder (polyvinylidene fluoride), and the resultant mixture was applied to Al foil using a doctor blade process. A mixing ratio among the positive active powder, the conductive agent and the binder was 8:1:1 by weight percent. The Al foil coated with the positive active material was dried for 24 hours in an oven at 120° C., and then pressed to prepare an anode for a pouch type battery. A half cell was manufactured by using the prepared anode and a Li counter electrode, and also using an electrolyte in which 1M LiPF₆ was dissolved in an organic solvent mixture of ethylene carbonate and dimethyl carbonate (mixed at 1:1 by volume percent).

The prepared positive active material was applied on an Al foil using a doctor blade. The Al foil coated with the positive active material was dried for 3 hours in an oven at 120° C., and then pressed to prepare an anode for a coin type battery. A coin type half cell was manufactured using the prepared anode and a Li counter electrode, and also using an electrolyte in which 1M LiPF₆ was dissolved in an organic solvent mixture of ethylene carbonate and dimethyl carbonate (mixed at 1:1 by volume percent).

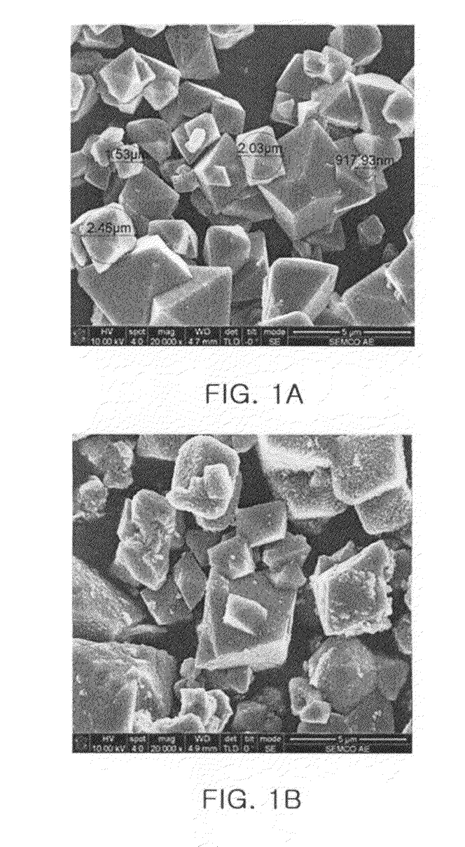

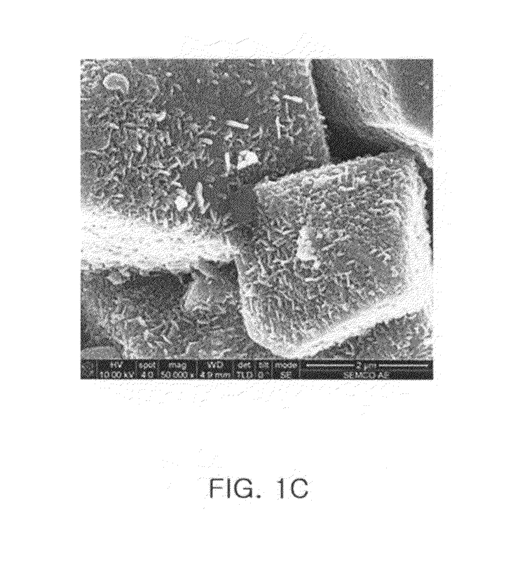

FIG. 1A to 1c illustrate scanning electron microscope (SEM) images of the positive active materials prepared according to the example and the comparative example detailed above.

FIG. 1A is a SEM image showing a LiMn₂O₄ positive active material of the comparative example, and FIG. 1B is a SEM image showing a LiMn₂O₄ positive active material prepared according to the example of the present invention which is surface-treated with a nickel oxide. FIG. 1C is an enlarged SEM image of FIG. 1B.

Referring to FIG. 1A, it can be observed from the SEM image that the surface of the LiMn₂O₄ positive active material of the comparative example is not surface-treated with other compounds.

When compared to FIG. 1A, it can be observed from the SEM images of FIGS. 1B and 1C that the surface of the LiMn₂O₄ positive active material surface-treated with the nickel oxide according to the example of the present invention is densely surface-treated with the nickel oxide.

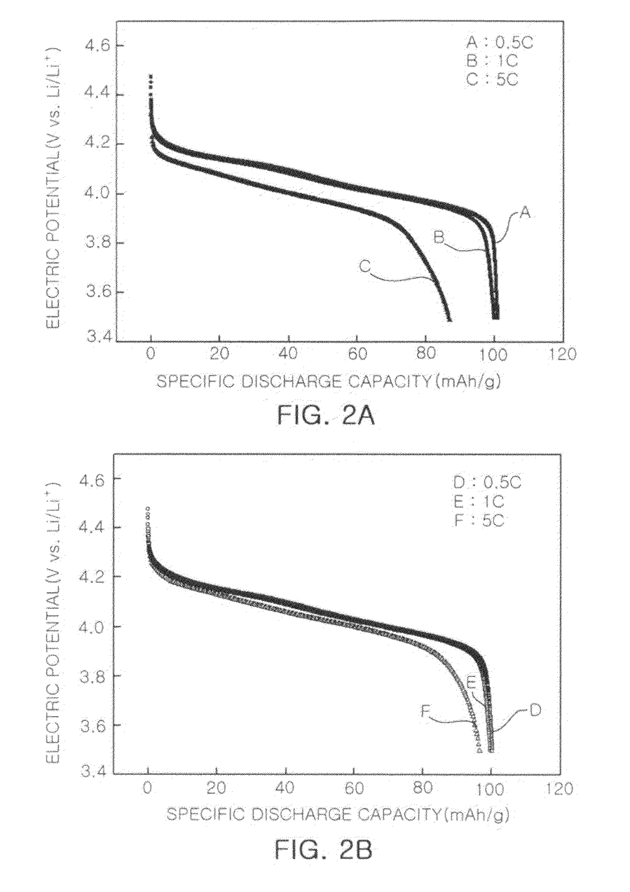

Charge/discharge properties of the positive active materials which were prepared by the example and the comparative example described above were measured at a high temperature (50° C.), and the results thereof are shown in Table 1, and FIGS. 2A and 2B.

FIG. 2A is a graph showing the charge/discharge properties of the LiMn₂O₄ positive active material of the comparative example, and FIG. 2B is a graph showing the charge/discharge properties of the LiMn₂O₄ positive active material surface-treated with the nickel oxide, which was prepared according to the example of the present invention.

Referring to Table 1 below and FIGS. 2A and 2B, it can be observed that specific discharge capacities (mAh/g) of both the LiMn₂O₄ positive active material that is not surface-treated with other compounds and the LiMn₂O₄ positive active material surface-treated with the nickel oxide tend to decrease at higher output power.

TABLE 1

| | 0.5 C | 1 C | 5 C |
|---|---|---|---|
| Comparative Example | 100.9 mAh/g | 99.7 mAh/g | 86.9 mAh/g |
| (LiMn₂O₄) | | | |
| Example | 100.4 mAh/g | 99.7 mAh/g | 96.6 mAh/g |
| (LiMn₂O₄ surface-treated | | | |
| with 2% by weight of nickel | | | |
| oxide) | | | |

However, it can be understood that the LiMn₂O₄ positive active material of the example that is surface-treated with the nickel oxide is smaller in the decrement of the specific discharge capacity (mAh/g) than the LiMn₂O₄ positive active material of the comparative example that is not surface-treated with other compounds.

Specifically, in the graph of FIG. 2A showing the charge/discharge properties of the LiMn₂O₄ positive active material of the comparative example that is not surface-treated with other compounds, reference symbols A, B and C denote specific discharge capacities measured at 0.5 C, 1 C and 5 C, respectively. Likewise, in the graph of FIG. 2B showing the charge/discharge properties of the LiMn₂O₄ positive active material of the example that is surface-treated with the nickel oxide, reference symbols D, E and F denote specific discharge capacities measured at 0.5 C, 1 C and 5 C, respectively.

It can be observed that from the graph of FIG. 2A that the specific discharge capacity decreases by about 13% as an output power rate increases by 10 times in the LiMn₂O₄ positive active material of the comparative example. Also, it can be observed from the graph of FIG. 2B that the specific discharge capacity decreases by about 3% as an output power rate increases by 10 times in the LiMn₂O₄ positive active material of the example.

As described above, since the LiMn₂O₄ positive active material is surface-treated with the nano-sized nickel oxide, the porosity and specific surface area thereof are increased at the surface of the LiMn₂O₄ positive active material, thereby increasing the specific discharge capacity in the nickel oxide as well as the LiMn₂O₄ positive active material.

Furthermore, as set forth previously, the nickel oxide has superior conductivity, and therefore, in the case where the LiMn₂O₄ positive active material is surface-treated with the nickel oxide, it is possible not only to improve the power density and energy density of the positive active material but also to minimize internal resistance. Accordingly, the LiMn₂O₄ positive active material may also be applicable to a hybrid supercapacitor requiring high power density as well as a rechargeable battery.

A method of surface-treating the LiMn₂O₄ positive active material with the nano-sized nickel oxide can be performed using the relatively simple above-described chemical synthetic process and therefore the positive active material according to the present invention is sufficiently competitive in terms of mass production and cost.

As set forth above, according to exemplary embodiments of the invention, it is possible to provide a positive active material coated with a metal oxide, which has excellent high-rate discharge performance without a decrease in capacity even at a higher discharge rate in comparison with a capacity at a low discharge rate (C-rate), and a method of preparing the positive active material.

While the present invention has been shown and described in connection with the exemplary embodiments, it will be apparent to those skilled in the art that modifications and variations can be made without departing from the spirit and scope of the invention as defined by the appended claims.

What is claimed is:

1. A positive active material comprising LiM_{2-y}N_{y}O₄ (0<y≦2, M and N are transition metals) surface-treated with a nickel (Ni)-containing compound.

2. The positive active material of claim 1, wherein the Ni-containing compound comprises at least one selected from the group consisting of a nickel oxide (NiO₁₋ₓ, 0≦x<1), a Ni alloy, and Ni.

3. The positive active material of claim 1, wherein the surface-treated amount of the Ni-containing compound is 2% or less by weight.

4. The positive active material of claim 1, wherein the transition metal comprises at least one selected from the group consisting of titanium (Ti), vanadium (V), chromium (Cr), manganese (Mn), cobalt (Co), and Ni.

5. A method of preparing a positive active material, comprising:
preparing a LiM_{2-y}N_{y}O₄ dispersion solution by dissolving LiM_{2-y}N_{y}O₄ powders (0<y≦2, M and N are transition metals) in an alcohol-based solvent;
preparing a nickel acetate-LiM_{2-y}N_{y}O₄ compound by adding nickel acetate to the LiM_{2-y}N_{y}O₄ dispersion solution and stirring the resultant mixture; and
surface-treating LiM_{2-y}N_{y}O₄ with a Ni-containing compound by thermally treating the nickel acetate-LiM_{2-y}N_{y}O₄ compound in an inert gas atmosphere.

6. The method of claim 5, wherein, in the surface-treating of the LiM_{2-y}N_{y}O₄, the Ni-containing compound comprises at least one selected from the group consisting of a nickel oxide (NiO₁₋ₓ, 0≦x<1), a Ni alloy, and Ni.

7. The method of claim 5, wherein, in the surface-treating of the LiM_{2-y}N_{y}O₄, the surface-treated amount of the Ni-containing compound is 2% or less by weight.

8. The method of claim 5, wherein the transition metal comprises at least one selected from the group consisting of Ti, V, Cr, Mn, Co, and Ni.

9. The method of claim 5, wherein, in the surface-treating of the LiM_{2-y}N_{y}O₄, the inert gas uses an argon (Ar) gas containing 5% by volume of hydrogen gas (H₂).

10. The method of claim 5, further comprising, before the surface-treating of the LiM_{2-y}N_{y}O₄, drying the nickel acetate-LiM_{2-y}N_{y}O₄ compound.
